(19) United States
(12) Patent Application Publication
(10) Pub. No.: US 2007/0188796 A1
(43) Pub. Date: Aug. 16, 2007

(54) Image processing apparatus and image processing method

(76) Inventor: Norio Saito, Tokyo (JP)

Correspondence Address: DICKSTEIN SHAPIRO LLP, 1825 EYE STREET NW, Washington, DC, 20006-5403, US

(21) Appl. No.: 11/656,961

(22) Filed: Jan. 24, 2007

(30) Foreign Application Priority Data
Feb. 13, 2006 (JP) 2006-035218

(51) Int. Cl. G06F 3/12

(52) U.S. Cl. 358/1.15

(57) ABSTRACT

An image processing apparatus includes a stream buffer that stores therein data that is to be subjected to image processing; a first counting unit that measures a volume of data that is input into the stream buffer. An analyzing unit reads the data from the stream buffer and analyses read data; and a second counting unit measures a volume of data that is output from the stream buffer to the analyzing unit. An error identifying unit identifies, when error occurs in the analyzing unit when analyzing the data, a part of the data where an error has occurred based on the volumes of data measured by the first counting unit and the second counting unit.

### CROSS-REFERENCE TO RELATED APPLICATIONS

The present document incorporates by reference the entire contents of Japanese priority document, 2006-035218 filed in Japan on Feb. 13, 2006.

### BACKGROUND OF THE INVENTION

1. Field of the Invention

The present invention relates to an image processing apparatus and an image processing method used to analyze data related to image processing.

2. Description of the Related Art

A printer description language (PDL) processing program generally operates on an image processing apparatus such as a document printing device (printer). The PDL processing program receives PDL data from a print controlling apparatus, such as a printer driver, and stores the PDL data in a temporary buffer. While the PDL data is being stored in the temporary buffer, the PDL processing program reads the PDL data from the temporary buffer unit by unit, such as token, analyzes and processes the PDL data.

Various error detection techniques that can be used on an image processing apparatus have been developed. There is known a technique, for example, that displays an error that has occurred during processing of the PDL data only when the error affects rendering of the PDL data (Japanese Patent Application Laid-Open Publication No. 2004-50562).

When an error occurs while the PDL processing program is processing the PDL data in a conventional printer, the printer performs a job reset operation or an error output operation. However, even if such an operation is performed, a user comes to know only the fact that an error has occurred, and does not get any idea which part of the PDL data is the cause of the error.

There is a need of a technology that can identify which part of the PDL data, i.e., how many bytes from a header of the PDL data, is the cause of the error.

### SUMMARY OF THE INVENTION

It is an object of the present invention to at least partially solve the problems in the conventional technology.

According to an aspect of the present invention, an image processing apparatus includes a stream buffer that stores therein data that is to be subjected to image processing; a first counting unit that measures a volume of data that is input into the stream buffer; an analyzing unit that reads the data from the stream buffer and analyses read data; a second counting unit that measures a volume of data that is output from the stream buffer to the analyzing unit; and an error identifying unit that identifies, when error occurs in the analyzing unit when analyzing the data, a part of the data where an error has occurred based on the volumes of data measured by the first counting unit and the second counting unit.

According to an aspect of the present invention, an image processing method includes storing data that is to be subjected to image processing in a stream buffer; first counting including measuring a volume of data that is input into the stream buffer; reading the data from the stream buffer and analyzing read data; second counting including measuring a volume of data that is output from the stream buffer at the reading; and identifying, when error occurs at the reading when analyzing the data, a part of the data where an error has occurred based on the volumes of data measured at the first counting and the second counting.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an image processing apparatus according to an embodiment of the present invention;

FIG. 2 is a flowchart of the operations performed by the image processing apparatus;

FIG. 3 is an example of PDL data;

FIG. 4A, FIG. 4B, and FIG. 4C explain a process of identifying a part where an error has occurred; and

FIG. 5 is a hardware configuration of the image processing apparatus.

### DETAILED DESCRIPTION OF THE PREFERRED EMBODIMENTS

Exemplary embodiments of the present invention will be explained in detail below with reference to the accompanying drawings.

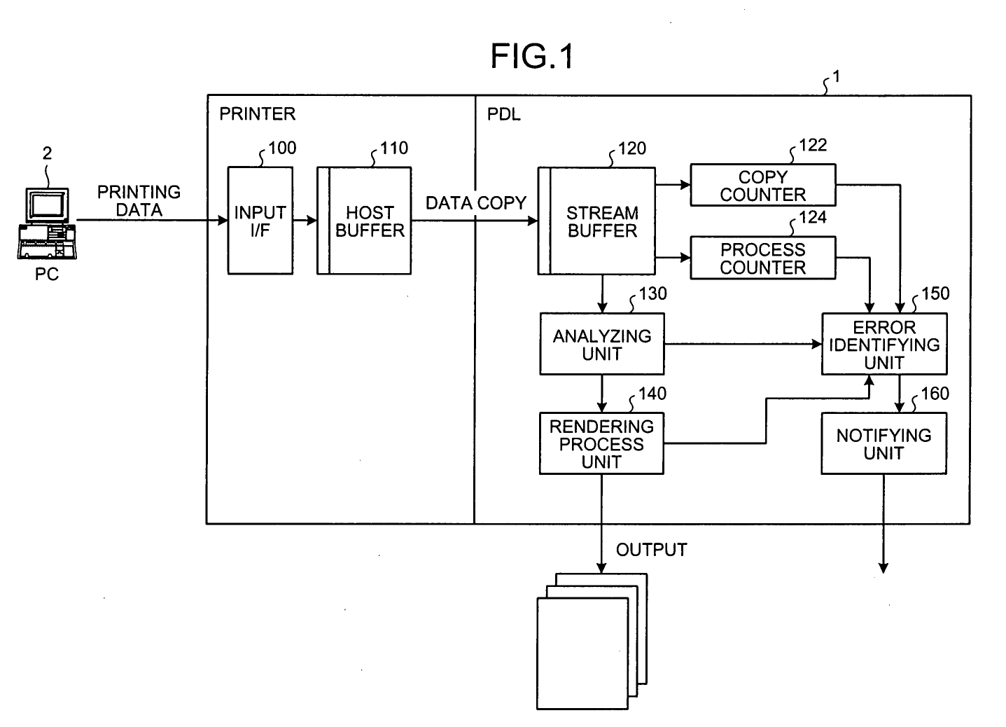

FIG. 1 is a block diagram of an image processing apparatus 1 according to an embodiment of the present invention. The image processing apparatus 1 is connected to a personal computer (PC) 2 through Ethernet or some other communication medium.

The image processing apparatus 1 includes an input interface (I/F) 100, a host buffer 110, a stream buffer 120, a copy counter 122, a process counter 124, an analyzing unit 130, a rendering process unit 140, an error identifying unit 150, and a notifying unit 160.

The input I/F 100 receives PDL data from the PC 2 and stores the same in the host buffer 110. The host buffer 110 has a limited capacity. In other words, when the host buffer 110 fills up, it can not receive any more data. Therefore, when the host buffer 110 fills up, a predetermined volume of the PDL data is transferred from the host buffer 110 into the stream buffer 120 thereby producing empty space in the host buffer 110 for the next PDL data.

A PDL processing program is installed in the image processing apparatus 1, and the PDL processing program uses the stream buffer 120. The PDL processing program can include a single program module or a plurality of program modules. Processes in each unit of the image processing apparatus 1 are realized by the PDL processing program.

The analyzing unit 130 reads the PDL data from the stream buffer 120 and analyzes the PDL data. The analyzing unit 130 analyzes a predetermined volume, for example a token, of the PDL data at a time. The rendering process unit 140 receives the analyzed PDL data from the analyzing unit 130 and performs rendering by using the analyzed PDL data.

The copy counter 122 and the process counter 124 are byte counters that respectively measure a data volume and store the same. The copy counter 122 measures the data volume that has been copied in the stream buffer 120 from the host buffer 110 in, for example, bytes. If the amount of the PDL data copied in the stream buffer 120 from the host buffer 110 is fixed, the copy counter 122 can be configured to count the number of times the data has been copied instead of measuring the data volume. Specifically, the copy counter 122 increments a counter each time the data is copied from the host buffer 110 to the stream buffer 120. Thus, from the count in the copy counter 122, it is possible to identify which data from the header of the PDL data has been currently copied from the host buffer 110 to the stream buffer 120.

The process counter 124 measures the data volume that has been output to the stream buffer 120, that is, the data volume that has been processed by the analyzing unit 130. Specifically, the process counter 124 increments a counter each time data is output from the stream buffer 120 to the analyzing unit 130. Thus, from the count in the process counter 124, it is possible to identify which data from the header of the PDL data has been currently analyzed by the analyzing unit 130.

The error identifying unit 150 calculates, when error occurs either in the analyzing unit 130 or in the rendering process unit 140, the difference between the counts of the copy counter 122 and the process counter 124. This allows the PDL processing program to identify a part of the PDL data from the header that has been processed. That is, if an error occurs, it is possible to identify the part of the PDL data where the error has occurred.

The notifying unit 160 notifies occurrence of an error, and a part identified by the error identifying unit 150 as the part where the error has occurred as well. Specifically, the occurrence of the error and the part where the error has occurred is displayed on a screen (not shown) of the image processing apparatus 1.

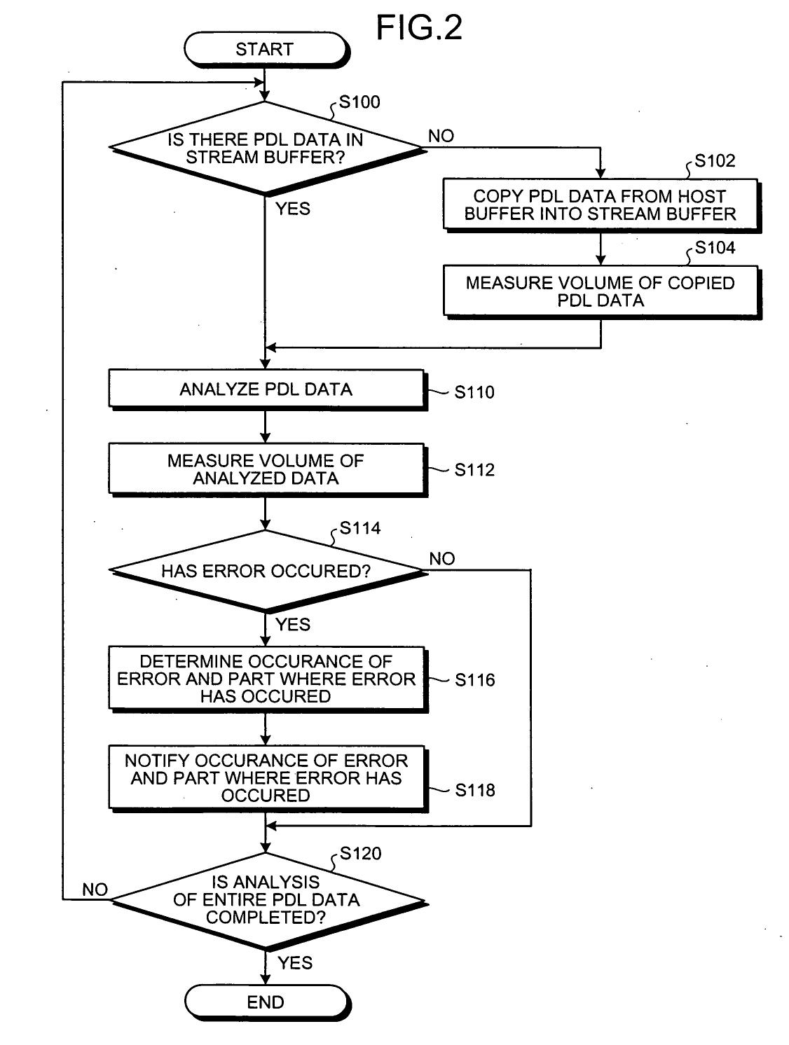

FIG. 2 is a flowchart of the operations performed by the image processing apparatus 1. First, the analyzing unit 130 confirms whether PDL data exists in the stream buffer 120. If there is no PDL data in the stream buffer 120 (NO at step S100), the PDL data is copied from the host buffer 110 into the stream buffer 120 (step S102). Next, the copy counter 122 measures the volume of the data, counted from the header of the PDL data, that has been currently copied from the host buffer 110 (step S104) into the stream buffer 120. Next, the analyzing unit 130 reads the PDL data from the stream buffer 120 and starts analyzing it (step S110). On the other hand, if the PDL data already exists in the stream buffer 120 (YES at step S100), the system control directly proceed to step S110.

The process counter 124 measures the volume of the PDL data that has been output from the stream buffer 120 to the analyzing unit 130 (step S112). If an error occurs while the analyzing unit 130 is analyzing the PDL data (YES at step S114), the error identifying unit 150 determines the occurrence of an error and the part where the error has occurred from the difference between the volume of the data measured by the copy counter 122 and the volume of the data measured by the process counter 124 (step S116). Next, the occurrence of the error and the part where the error has occurred is notified (step S118). The process is repeated till the completion of the analysis of the entire PDL data (step S120).

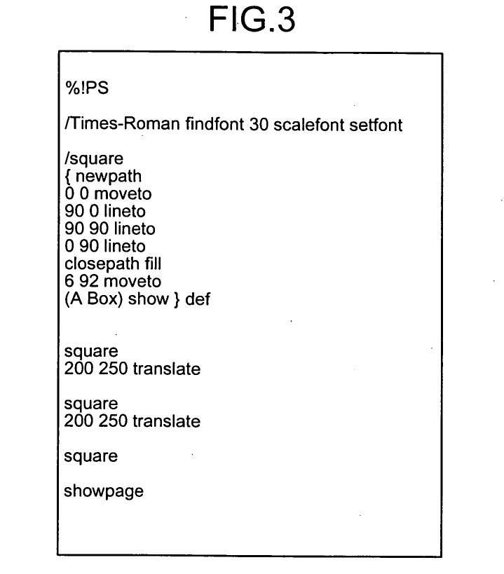

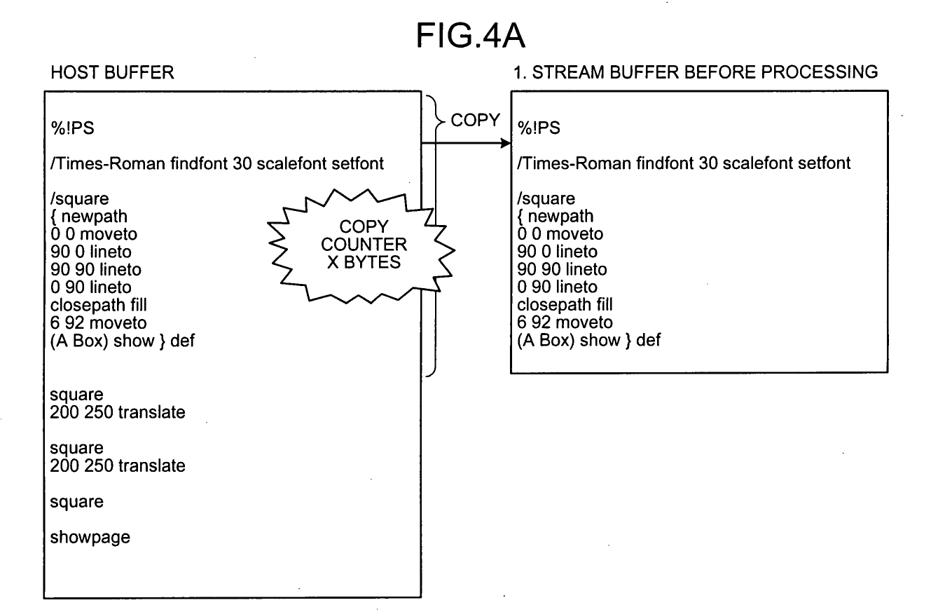

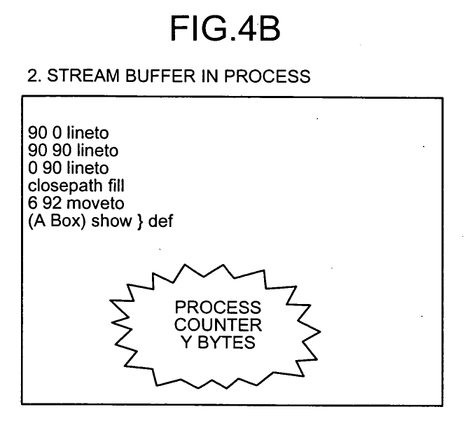

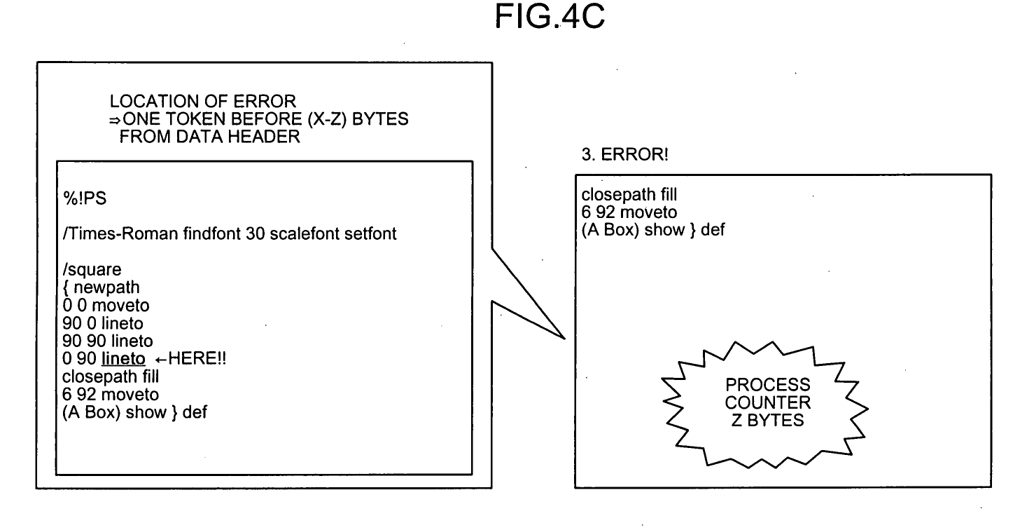

A specific example is explained below with reference to FIG. 3 and FIG. 4A to FIG. 4C. An example of the PDL data is shown in FIG. 3. FIG. 4A to FIG. 4C are for explaining how the part in the PDL data where the error has occurred can be identified. PDL data that is in the form shown in FIG. 3 is acquired from the PC 2 and stored in the host buffer 110. At this time, first X bytes of the PDL data are copied from the host buffer 110 to the stream buffer 120, as shown in FIG. 4A, and the copy counter 122 counts X bytes as volume of the PDL data copied from the host buffer 110 to the stream buffer 120.

When the PDL data is output from the stream buffer 120 to the analyzing unit 130, the process counter 124 measures the volume of the PDL data that is output from the stream buffer 120 to the analyzing unit 130 as Y byte as shown in FIG. 4B. If an error occurs, as shown in FIG. 4C, at Z byte point as measured by the process counter 124, the error identifying unit 150 calculates the difference between X and Z, and identifies one token before (X-Z) bytes from the header of the PDL data as the part where the error has occurred. In the example shown in FIG. 4C, “090 lineto” is the part where the error has occurred.

Thus, the image processing apparatus 1 according to the embodiment can identify and notify the occurrence of an error and the part of the PDL data that is the cause of the error.

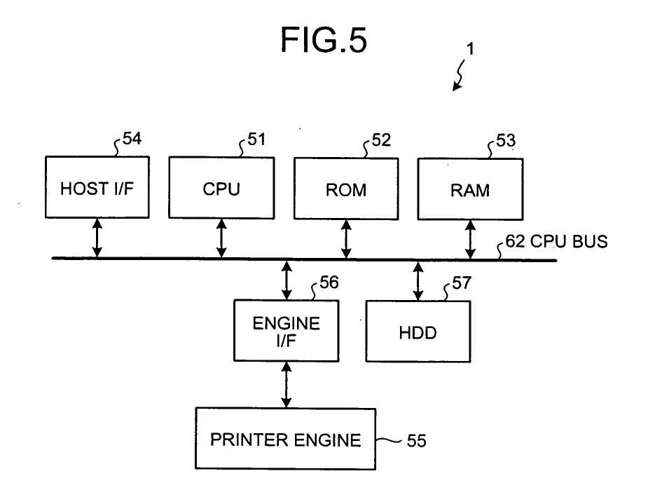

FIG. 5 is a hardware configuration of the image processing apparatus 1. The image processing apparatus 1 includes a read only memory (ROM) 52, where computer programs needed for executing image processing are stored, a central processing unit (CPU) 51 that controls each part of the image processing apparatus 1 following the computer program present in the ROM 52, a random access memory (RAM) 53 that stores therein a variety of data required for controlling the image processing apparatus 1, an engine I/F 56 that connects a host interface 54 and a printer engine 55, a hard disk drive (HDD) 57 that stores therein various data, and a CPU bus 62 that connects all the above units to each other.

A computer program (hereinafter, “image processing program”) used in the image processing apparatus 1 can be provided in the form of installable or executable files on a computer-readable storing medium. A compact disk read only memory (CD-ROM), a floppy disk-read (FD-R), a digital versatile disk (DVD) are the examples of the computer-readable storing medium.

When the image processing program is provided on the computer-readable storing medium, the image processing apparatus 1 reads the image processing program from the computer-readable storing medium, loads the image processing program into a main memory (not shown), and executes the image processing program. With the execution of the image processing program, the functional units of the image processing apparatus 1 are realized as software units on the main memory.

Alternatively, the image processing program can be stored on a different computer that is connected to the image processing apparatus 1 through a network such as the Internet. In this case, the image processing apparatus 1 downloads the image processing program from the different computer and executes the image processing program.

The respective procedures explained in the embodiment can be modified or improved in many ways.

As one alternative, instead of incrementing a count in the process counter 124 based on volume of data output from the stream buffer 120, it is conceivable to decrement the count of the copy counter 122 in the process counter 124 based on volume of data output from the stream buffer 120. In such a configuration, the error identifying unit 150 identifies the part of the PDL data that has caused an error based on the count in the copy counter 122.

In another alternative, the volume of the data that is to be copied from the host buffer 110 to the stream buffer 120 can be made variable. The act of making the volume of data variable does not necessarily need any change in the configuration or processing of the copy counter 122.

According to an aspect of the present invention, it is possible to determine accurately which part of the PDL data is the cause of an error and notify the part to the user.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a stream buffer that stores therein data that is to be subjected to image processing;
a first counting unit that measures a volume of data that is input into the stream buffer;
an analyzing unit that reads the data from the stream buffer and analyses read data;
a second counting unit that measures a volume of data that is output from the stream buffer to the analyzing unit; and
an error identifying unit that identifies, when error occurs in the analyzing unit when analyzing the data, a part of the data where an error has occurred based on the volumes of data measured by the first counting unit and the second counting unit.

2. The image processing apparatus according to claim 1, wherein the first counting unit and the second counting unit are increment counters.

3. The image processing apparatus according to claim 1, wherein the first counting unit is an increment counter and the second counting unit is a decrement counter that decrements the volume of data counted by the first counting unit.

4. The image processing apparatus according to claim 1, further comprising a host buffer that sends data to the stream buffer, wherein
the first counting unit that measures a volume of data that is input into the stream buffer from the host buffer.

5. The image processing apparatus according to claim 4, wherein volume of data sent from the host buffer to the stream buffer is variable.

6. An image processing method comprising:
storing data that is to be subjected to image processing in a stream buffer;
first counting including measuring a volume of data that is input into the stream buffer;
reading the data from the stream buffer and analyzing read data;
second counting including measuring a volume of data that is output from the stream buffer at the reading; and
identifying, when error occurs at the reading when analyzing the data, a part of the data where an error has occurred based on the volumes of data measured at the first counting and the second counting.
